(19) United States
(12) Patent Application Publication
(10) Pub. No.: US 2025/0250698 A1
(43) Pub. Date: Aug. 7, 2025

(54) CATALYST FOR HYDROGEN EVOLUTION REACTION CONTAINING RUTHENIUM-BASED ALLOY, WATER ELECTROLYSIS ELECTRODE CONTAINING THE SAME, AND METHOD OF MANUFACTURING THE SAME

(71) Applicant: KOREA INSTITUTE OF SCIENCE AND TECHNOLOGY, Seoul (KR)

(72) Inventors: Jaewon LEE, Seoul (KR); Junhyeong KIM, Seoul (KR); Jin-ho OH, Seoul (KR); Katie Heeyum LIM, Seoul (KR); Bora SEO, Seoul (KR); Hee-Young PARK, Seoul (KR); So Young LEE, Seoul (KR); Sung Jong YOO, Seoul (KR); Jin Young KIM, Seoul (KR); Jong Hyun JANG, Seoul (KR); Hyun S. PARK, Seoul (KR); Sung Ki CHO, Seoul (KR)

(21) Appl. No.: 18/795,522

(22) Filed: Aug. 6, 2024

(30) Foreign Application Priority Data
Feb. 5, 2024 (KR) 10-2024-0017527

(51) Int. Cl. C25B 11/052; C25B 9/23; C25B 11/063; C25B 11/065; C25B 11/089; C25D 3/56; C25D 5/54

(52) U.S. Cl. CPC C25B 11/052; C25B 9/23; C25B 11/063; C25B 11/065; C25B 11/089; C25D 3/567; C25D 5/54

(57) ABSTRACT

Disclosed herein are a catalyst for a hydrogen evolution reaction, a water electrolysis electrode including the same, and a method of manufacturing the same, wherein the catalyst can be manufactured at room temperature, and catalyst diversity can be given through an alloy structure including ruthenium and two or more metals. According to the present disclosure, the catalyst can be manufactured at room temperature due to characteristics of an electroplating manufacturing method, and the catalyst diversity can be given through the alloy structure that includes ruthenium and two or more metals.

### CROSS REFERENCE TO RELATED APPLICATION

The present application claims priority to Korean Patent Application No. 10-2024-0017527, filed on Feb. 5, 2024, the entire contents of which is incorporated herein for all purposes by this reference.

### BACKGROUND OF THE INVENTION

### Field of the Invention

### Description of Government-Sponsored Research

This research was supported by the Ministry of Science and ICT of the Republic of Korea under the administration of the Korea Institute of Science and Technology, and (KIST), and the research project name is the Korea Institute of Science and Technology's research operating expenses support (R&D) (main project expense), and the research subject name is Development of Core Technology for the Unitization of Green Hydrogen Production and LOHC Storage (Subproject Number: 1711196511).

This research was supported by the Ministry of Science and ICT of the Republic of Korea under the administration of the Korea Institute of Science and Technology, and the research project name is the Independent Research Project, and the research subject name is (Brain Pool Fellowship) Development of pH-universal Non-Pt Catalyst and Electrode of Water Splitting for Green Hydrogen Production.

This research was supported by the Ministry of Trade, Industry and Energy of the Republic of Korea under the administration of the Korea Evaluation Institute for Industrial Technology, and the research project name is the Development of Material Component Technology, and the subject name is Development of high-performance catalytic electrodes and parts technology on 2.5 kW-class AEM water electrolysis using waste-alkali solution for hydrogen production (Subproject Number: 1415186228).

This research was supported by the Ministry of Science and ICT of the Republic of Korea under the administration of the National Research Foundation of Korea (NRF), and the research project name is the Nano & Material Technology Development Program, and the research subject name is the Development of commercialization technology for avoidance of platinum-carbon materials for water electrolysis electrodes through optimizations of adsorption strength and mass transport (Subproject Number: 1711186472).

The present disclosure relates to a catalyst for a hydrogen evolution reaction including a ruthenium-based alloy, a water electrolysis electrode including the same, and a method of manufacturing the same. More specifically, the present disclosure relates to a catalyst for a hydrogen evolution reaction, a water electrolysis electrode including the same, and a method of manufacturing the same, in which the catalyst can be manufactured at room temperature due to the characteristics of an electroplating method, in which the diversity of the catalyst can be given through an alloy structure including ruthenium and two or more metals, and in which an activity change can be observed through control of the electronic structure of the catalyst according to an elemental composition.

### Description of the Related Art

Water electrolysis is a technique that may produce hydrogen, which is the next generation energy source, and is an eco-friendly energy conversion method that is capable of producing hydrogen from water. In particular, water electrolysis technology using polymer electrolyte membranes is capable of producing hydrogen with high purity and may be an essential technology for the revitalization of the hydrogen economy.

However, with regard to the current issues associated with the development of a polymer electrolyte membrane water electrolysis (PEMWE), although the driving protocol and energy conversion efficiency have achieved a high technology level, it is currently difficult to commercialize water electrolysis due to the high unit cost of hydrogen production.

Specifically, among the constituent elements of the PEMWE, membrane-electrode assembly (MEA), which comprises an electrode and a polymeric membrane, is a key element of determining the performance of water electrolysis. However, the MEA accounts for roughly 25% of the total price of the elements that constitute the water electrolysis. In particular, platinum, which is mainly used as an electrode catalyst material for the water electrolysis, has adequate hydrogen adsorption energy and exhibits excellent activity in the hydrogen evolution reaction, but it is difficult to continuously develop the electrode catalyst using platinum due to the problem of cost and scarcity.

Therefore, the development of a highly active and durable electrode catalyst with reduced platinum usage may be a key strategy for the commercialization of the water electrolysis. Recently, the development of electrode catalyst based on various alloys has been proceeding to replace platinum materials, and the hydrogen adsorption energy is attempted to be adjusted by controlling the alloying and electronic structure of each material.

Meanwhile, in an electrode catalyst manufacturing process, a spray coating method of general catalyst slurry has the disadvantage of having a dense catalyst layer, which causes an increase in resistance to ohmic and mass transfer, and having a poor utilization of an internal catalyst layer, and in the case of spray coating, the process up to manufacturing an electrode is very complicated, such as making a catalyst and coating the catalyst on a gas diffusion layer.

As a result, there is a need for a strategy to develop a catalyst electrode for water electrolysis based on an alloy that is capable of replacing platinum materials through a relatively simple electrode manufacturing process.

### SUMMARY OF THE INVENTION

In the present specification, there is provided a catalyst for a hydrogen evolution reaction (HER), which can be used as a hydrogen evolution electrode in a polymer electrolyte water electrolysis because an alloy catalyst is easily applied as an electrode and the electrode is easily made to have a large surface area, a water electrolysis electrode including the same, and a method of manufacturing the same.

In an exemplary embodiment of the present disclosure, there is provided a catalyst for a hydrogen evolution reaction, the catalyst including: a support; and a ruthenium alloy electroplated on the support, in which the alloy includes ruthenium, and two or more metals selected from the group consisting of Au, Ni, Co, Mo, and Cu.

In another exemplary embodiment of the present disclosure, there is provided a hydrogen evolution electrode that includes the catalyst described above.

In still another exemplary embodiment of the present disclosure, there is provided a water electrolysis electrode that includes the hydrogen evolution electrode described above.

In yet another exemplary embodiment of the present disclosure, there is provided a method of manufacturing a catalyst for a hydrogen evolution reaction, the method including: preparing a precursor including a ruthenium precursor and two or more metals selected from the group consisting of Au, Ni, Co, Mo, and Cu; and electroplating a ruthenium alloy on a support using the precursor.

According to the present disclosure, the catalyst is manufactured directly on the support using electroplating, thereby providing excellent bonding between the catalyst and the support, resulting in excellent durability for an electrochemical reaction.

According to the present disclosure, the catalyst diversity can be given through an alloy structure that includes ruthenium and two or more elements, and a change in activity can be observed through control of the electronic structure of the catalyst according to an elemental composition.

According to the present disclosure, the catalyst can be manufactured at room temperature due to the characteristics of electroplating, and various variables such as a plating potential, a plating time, a concentration of an electrolyte solution, and the like can be easily controlled, so that the catalyst having various characteristics can be manufactured.

### BRIEF DESCRIPTION OF THE DRAWINGS

FIGS. 1A and 1B are results of evaluating HER activity on Ru-based binary and ternary alloy catalysts according to one embodiment of the present disclosure.

FIGS. 2A, 2B and 2C illustrate scanning electron microscope (SEM) images of catalysts for a hydrogen evolution reaction according to one embodiment of the present disclosure.

FIGS. 3A, 3B and 3C are results of observing spectra on energy dispersive X-ray spectroscopy (EDS) analysis of the catalysts for a hydrogen evolution reaction according to one embodiment of the present disclosure.

FIGS. 4A, 4B and 4C are results of analyzing HER activity in an acidic atmosphere of the catalysts for a hydrogen evolution reaction according to one embodiment of the present disclosure.

FIG. 5 is a result of analyzing a polymer exchange membrane water electrolysis activity of the catalyst for a hydrogen evolution reaction according to one embodiment of the present disclosure.

FIGS. 6A and 6B are results of analyzing the performance according to plating potential of the catalyst for a hydrogen evolution reaction according to one embodiment of the present disclosure.

FIG. 7 is a result of analyzing the performance according to electrolyte concentration of the catalyst for a hydrogen evolution reaction according to one embodiment of the present disclosure.

FIGS. 8A and 8B are results of analyzing the performance according to plating potential of the catalyst for a hydrogen evolution reaction according to one embodiment of the present disclosure.

### DETAILED DESCRIPTION OF THE INVENTION

Hereinafter, exemplary embodiments of the present disclosure will be described in detail with reference to the accompanying drawings.

The embodiments of the present disclosure disclosed herein are illustrated for purposes of description only, and the embodiments of the present disclosure may be practiced in various forms and should not be interpreted as limiting to the embodiments described herein.

The present disclosure is subject to various modifications and may have various forms, and the embodiments are not intended to limit the present disclosure to any particular disclosure form, but are to be understood to include all modifications, equivalents, or substitutions that fall within the scope of the spirit and art of the present disclosure.

In the present specification, unless explicitly described to the contrary, the word “comprise” or “include” and variations, such as “comprises”, “comprising”, “includes” or “including”, will be understood to imply the inclusion of stated constituent elements, not the exclusion of any other constituent elements.

### Catalyst for Hydrogen Evolution Reaction

In an exemplary embodiment of the present disclosure, there is provided a catalyst for a hydrogen evolution reaction, the catalyst including: a support; and a ruthenium alloy electroplated on the support, in which the alloy includes ruthenium, and two or more metals selected from the group consisting of Au, Ni, Co, Mo, and Cu.

Unlike conventional ruthenium-based catalysts, a ruthenium-based alloy catalyst manufactured by electroplating according to the present disclosure may further include two or more metals in addition to ruthenium to exhibit a stable hydrogen adsorption energy due to an adequate elemental composition between materials. Therefore, the ruthenium-based alloy catalyst exhibits excellent activity for an electrochemical hydrogen evolution reaction, and due to the characteristics of the electroplating manufacturing method, the manufactured alloy catalyst is easily applied as an electrode and the electrode is easily made to have a large surface area, so that the ruthenium-based alloy catalyst can be used as a hydrogen evolution electrode for polymer electrolyte water electrolysis.

In one embodiment, the support may be titanium or carbon, in which the titanium may be titanium foil, Ti porous transport layer (PTL) or titanium paper, in which the carbon may be carbon paper or carbon felt.

In one embodiment, the ruthenium alloy may include ruthenium, Au, and Mo.

In one embodiment, the ruthenium alloy may be represented by Chemical Formula 1 below.

RuₓAu_{y}Mo_{(1-y)} [Chemical Formula 1]

In Chemical Formula 1, x is 1, and y is 0 to 1.

Another exemplary embodiment of the present disclosure provides a hydrogen electrode that includes the catalyst described above.

Still another exemplary embodiment of the present disclosure provides water electrolysis electrode that includes the hydrogen electrode described above.

In one embodiment, the water electrolysis electrode may be a PEMWE electrode.

### Method of Manufacturing Catalyst for Hydrogen Evolution Reaction

In yet another exemplary embodiment of the present disclosure, there is provided a method of manufacturing a catalyst for a hydrogen evolution reaction, the method including: preparing a precursor including a ruthenium precursor and two or more metals selected from the group consisting of Au, Ni, Co, Mo, and Cu; and electroplating a ruthenium alloy on a support using the precursor.

According to the present disclosure, it is possible to (1) manufacture a ruthenium-based alloy catalyst by electroplating, (2) adjust the composition and loading amount of the alloy catalyst by controlling electroplating parameters, (3) observe the resulting changes in hydrogen evolution reaction activity, and (4) apply the manufactured alloy catalyst as an electrode for polymer electrolyte water electrolysis and evaluate activity for hydrogen production.

In one embodiment, the support may be titanium or carbon, in which the titanium may be titanium foil, Ti PTL or titanium paper, in which the carbon may be carbon paper or carbon felt.

In one embodiment, the precursor including two or more metals selected from the group consisting of Au, Ni, Co, Mo, and Cu may include an Au precursor and a Mo precursor.

In one embodiment, the precursor including two or more metals selected from the group consisting of Au, Ni, Co, Mo, and Cu may include an Au precursor and a Mo precursor, and

A concentration ratio of the ruthenium precursor, Au precursor, and Mo precursor may be 1:0.05 to 0.5:0.05 to 0.25. For example, the concentration ratio may be 1:0.05 to 0.5:0.05 to 0.25, or 1:0.1 to 0.5:0.1 to 0.25.

In one embodiment, the loading amount of ruthenium, Au, and Mo may each be 0.01 to 1 mg/cm², for example, the loading amount for each element may be approximately 0.1 mg/cm².

In one embodiment, the method may be performed at room temperature.

In one embodiment, the electroplating potential may be −0.4 to −0.8 V_{Ag/AgCl}.

For example, the electroplating potential may be −0.4 V_{Ag/AgCl} or more, −0.5 V_{Ag/AgCl} or more, −0.6 V_{Ag}/AgCl or more, or −0.7 V_{Ag}/AgCl or more, and may be −0.8 V_{Ag}/AgCl or less, −0.7 V_{Ag/AgCl} or less, −0.6 V_{Ag/AgCl} or less, −0.55 V_{Ag}/AgCl or less, or −0.5 V_{Ag}/AgCl or less.

For example, the electroplating potential may be −0.4 to −0.55 V_{Ag/AgCl}.

In one embodiment, the electroplating time may be 3 to 30 minutes.

For example, the electroplating time may be 3 minutes or more, 5 minutes or more, 10 minutes or more, 15 minutes or more, 20 minutes or more, or 25 minutes or more, and may be 30 minutes or less, 25 minutes or less, 20 minutes or less, 15 minutes or less, 10 minutes or less, 5 minutes or less.

The present disclosure will be described in more detail in the following examples. However, the examples are intended to illustratively describe the present disclosure and the scope of the present disclosure is not limited by the following examples.

### EXAMPLES

### Example 1—Manufacturing of a Ru Alloy Through Solution Synthesis Method for HER Activity Screening by Composition (Optimal Alloy Combination being Derived)

Using a simple solution synthesis method, various Ru-based binary and ternary alloys were manufactured and HER activity thereon was evaluated. Metal precursors used to manufacture the Ru-based binary and ternary alloys are as follows; Au, Ni, Co, Mo, and Cu.

The solution composition was formulated such that the concentration of a Ru precursor was fixed at 20 mM, and the concentration ratio of each metal precursor was 1:1:1 (Ru₁Au₁Mo₁, elemental molar ratio 1:1:1). The prepared Ru-based binary and ternary solutions were dropcast onto Ti foil (1 cm×1 cm) and proceeded to heat treatment.

Then, the HER evaluation in half-cell was proceeded using the Ru-based binary and ternary catalysts manufactured on the Ti foil. The HER evaluation was proceeded in 1 M H₂SO₄ and 1 M NaOH, respectively.

### Example 2—Manufacturing RuAuMo Electrode Catalyst Using Electroplating

First, an electrolyte was manufactured to be used for electroplating. The composition of the electrolyte was configured as 0.25 M HClO₄+20 mM RuCl₃+2 mM HAuCl₄+2 mM Na₂MoO₄. Three-electrode configuration is as follows; a working electrode: Ti foil (half-cell) Ti PTL (single cell), a reference electrode: Ag/AgCl (saturated KCl), and an auxiliary electrode: Pt wire.

The electroplating area is 0.55 cm² (half-cell) and 12.57 cm² (single cell), and a surface oxide layer was removed from the working electrode through acid treatment before electroplating. The removal of the surface oxide layer of the working electrode was proceeded by immersion in 5% oxalic acid heated to 60° C. for 30 minutes. After the acid treatment, the working electrode was washed with distilled water and proceeded with a drying process.

The electroplating was proceeded hourly at a plating potential of −0.55 V_{Ag/AgCl}. After the electroplating has been completed, the manufactured sample was washed with distilled water and proceeded with a drying process.

### Experimental Example 1—Evaluation of HER Activity in Half-Cell

The activity evaluation on the HER was proceeded using the RuAuMo electrode catalyst on the Ti foil manufactured in Example 1 as the working electrode of the half-cell, and the evaluation was measured using linear scanning voltammetry (LSV).

Ag/AgCl (saturated KCl) was used as the reference electrode of the half-cell, and a Pt wire was used as the auxiliary electrode thereof 1 M H₂SO₄ was used as the electrolyte for the HER activity evaluation, with an active area of 0.5 cm².

The LSV evaluation was measured from open circuit potential (OCP) down to −0.4 V_{Ag/AgCl}, after which the potential was converted to RHE.

To compare the HER activity, the HER activity evaluation was proceeded in the same manner on Comparative Examples 1 and 2.

### Experimental Example 2—Performance Evaluation of PEMWE Unit Cell

The activity evaluation on water electrolysis was proceeded using the RuAuMo electrode catalyst on the Ti PTL manufactured in Example 2 as a hydrogen evolution electrode of the PEMWE. A PtIr electrode catalyst manufactured by double plating on the Ti PTL was used as an oxygen evolution electrode, and a Nafion 212 was used as a membrane. MEA was manufactured and a PEMWE unit cell was manufactured using the prepared hydrogen evolution electrode, oxygen evolution electrode, and membrane.

The temperature of the unit cell was maintained at 80° C. using a temperature controller, and distilled water was injected into the oxygen evolution electrode at a flow rate of 15 cc/min.

To activate the unit cell, a voltage of 1.55 V was applied for 30 minutes, after which LSV was measured from OCV to 2.0 V at a refresh rate of 10 mV/s.

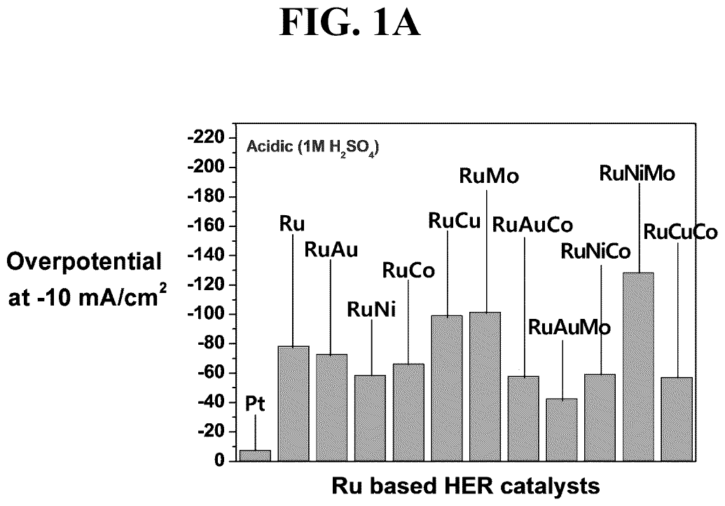

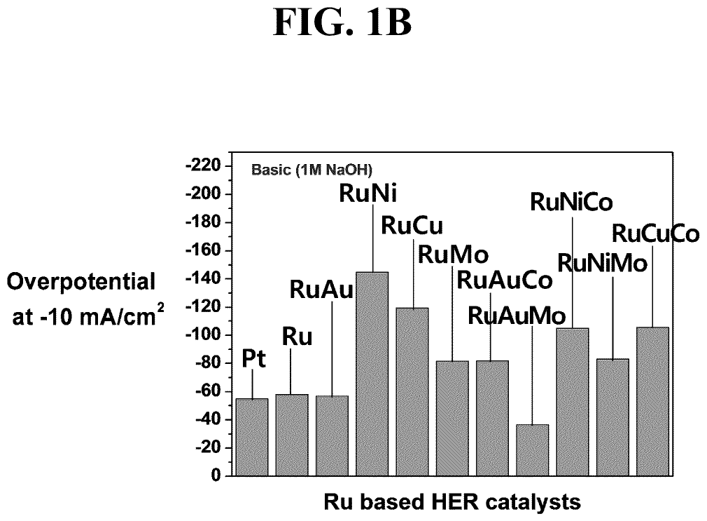

FIGS. 1A and 1B are results of evaluating HER activity on Ru-based binary and ternary alloy catalysts according to one embodiment of the present disclosure.

It was confirmed that the non-platinum alloy catalyst configured as Ru—Au—Mo exhibited the best HER activity among the manufactured Ru-based alloy catalysts, resulting in the identification of the best HER activity, as a result of the HER evaluation on the Ru-based binary and ternary alloy catalysts of Example 1 proceeded in 1 M H₂SO₄ (FIG. 1A) and 1 M NaOH (FIG. 1B) solutions, respectively.

Then, catalysts with different compositions configured with Ru, RuAu, and RuAuMo were manufactured and the HER activity evaluation according to the properties was proceeded.

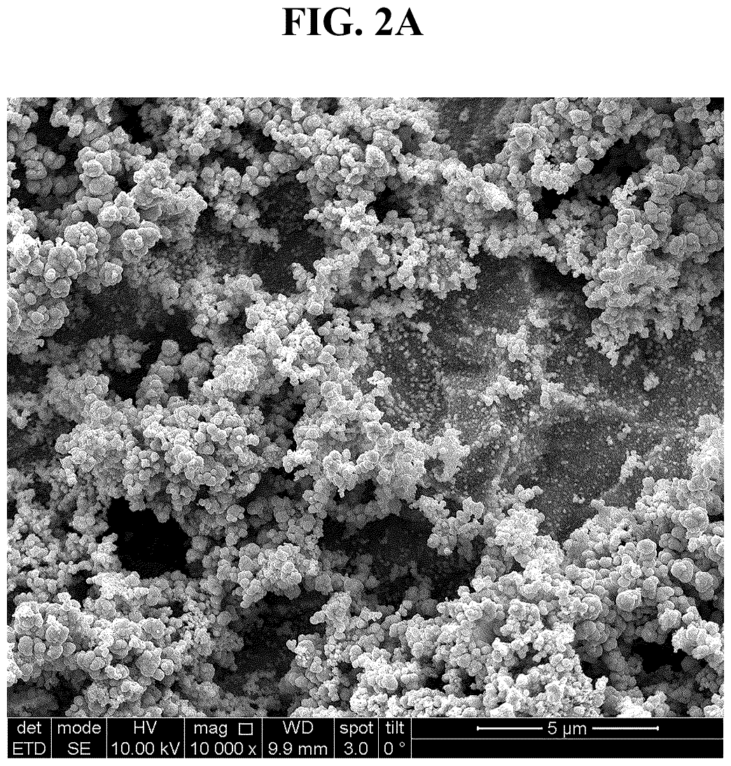

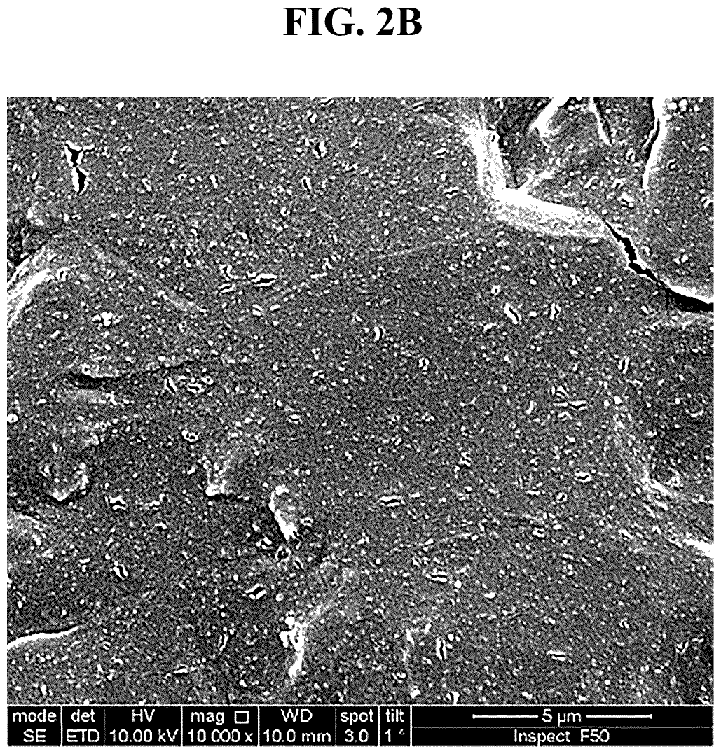

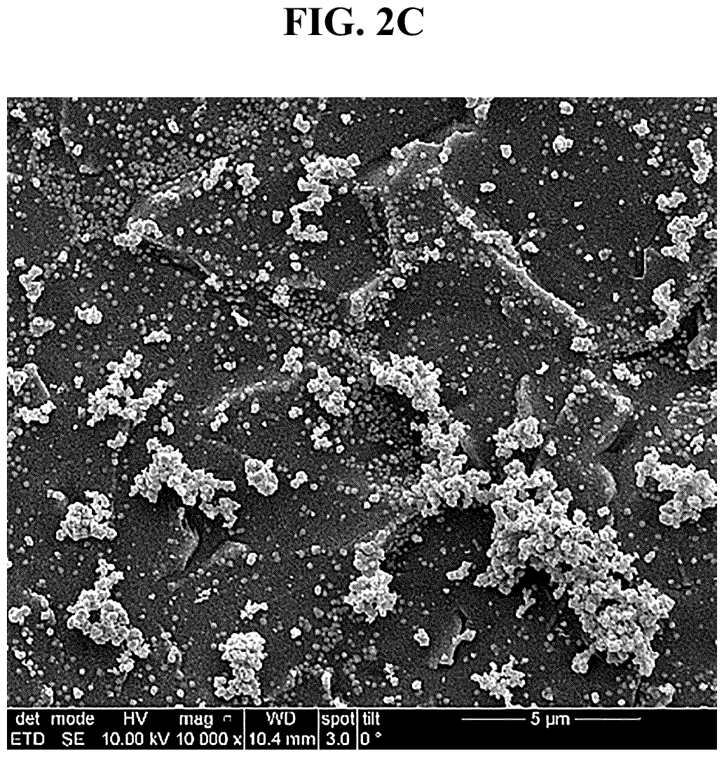

FIGS. 2A to 2C illustrate SEM images of catalysts for the hydrogen evolution reaction according to one embodiment of the present disclosure.

FIG. 2A is a SEM image of a surface of the electrode that includes RuAuMo manufactured in Example 2, in which it was confirmed that nano particles having a size of 200-300 nm were electrodeposited on a surface of a Ti support through SEM analysis. Each particle is agglomerated together and has sufficient pores.

FIG. 2B is a SEM image of the electroplated electrode surface of Comparative Example 1 (Ru), which was manufactured on the Ti support by the same method as Example 2 except for Au and Mo in the electrolyte.

It was confirmed that Ru, comprising thin films or nanoparticles, was electrodeposited on the surface of the Ti support through SEM analysis.

FIG. 2c is a SEM image of the electrode surface of Comparative Example 2 (RuAu), which was manufactured on the Ti support by the same method as Example 2 except for Mo in the plating electrolyte.

It was confirmed that RuAu nanoparticles with a size of 200 to 300 nm were electrodeposited on the surface of Ti support through SEM analysis.

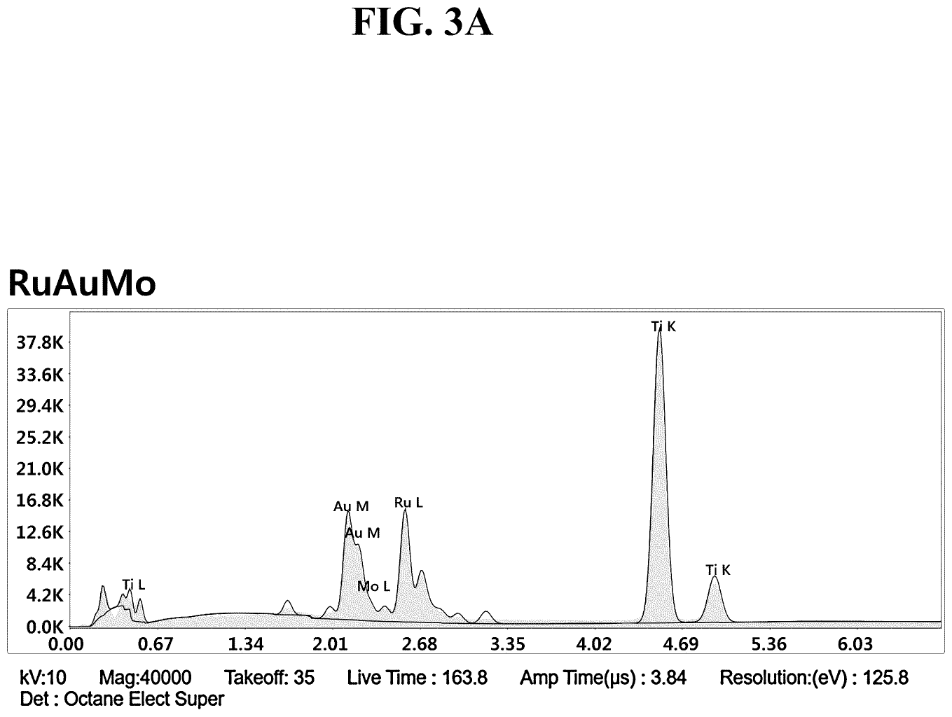

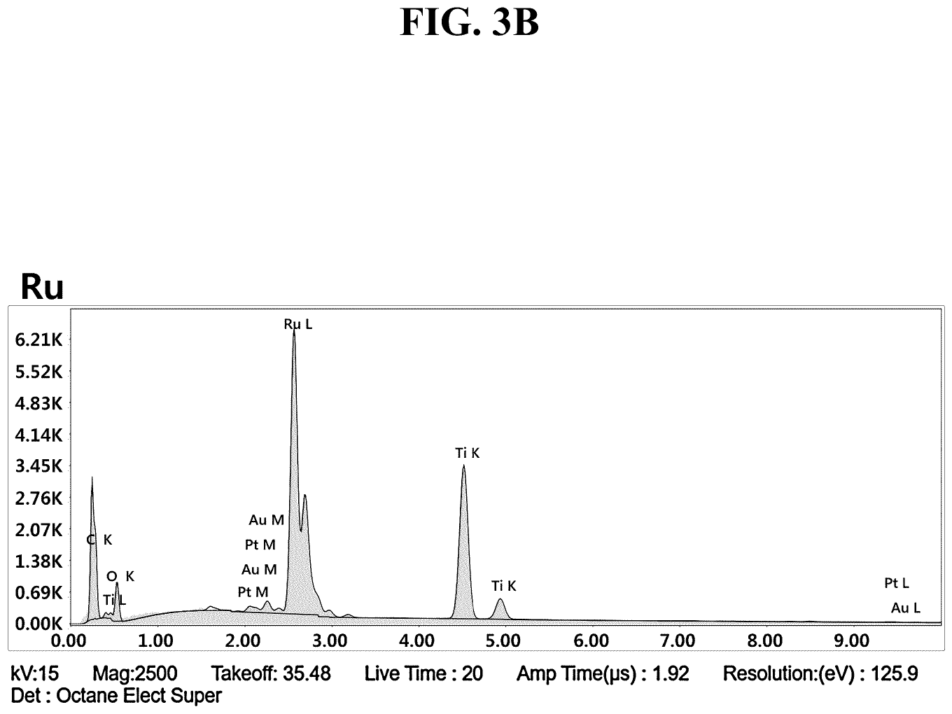

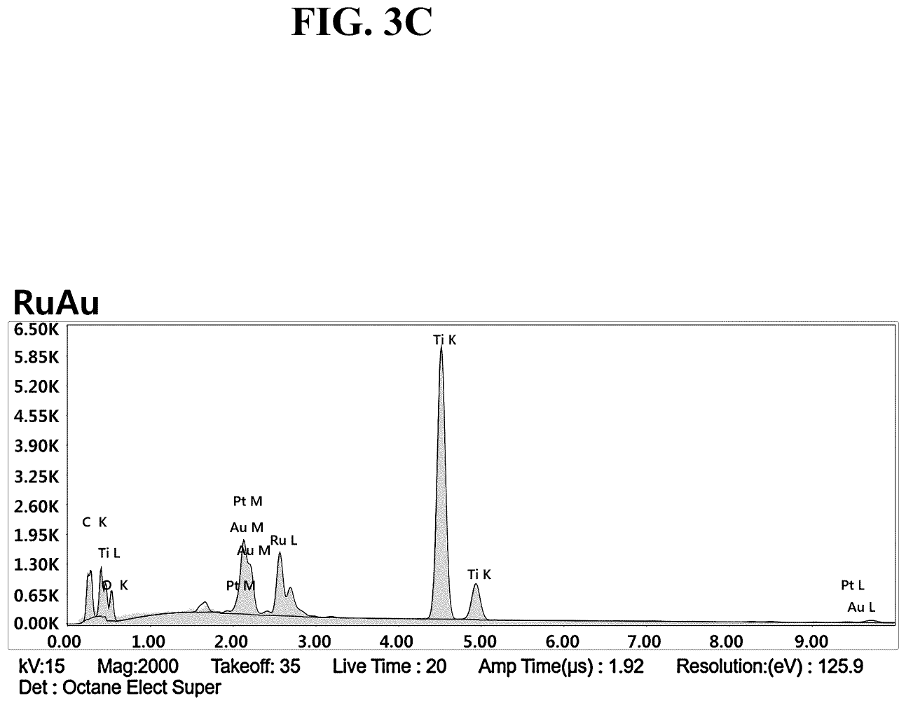

FIGS. 3A to 3C are results of observing spectra on EDS analysis of the catalysts for the hydrogen evolution reaction according to one embodiment of the present disclosure. The bulk EDS composition analysis was proceeded on the manufactured Example 2 and Comparative Examples 1 and 2.

FIG. 3A is a spectrum for EDS analysis of RuAuMo (Example 2), the composition of which was confirmed to be Ru₁Au_{0.9}Mo_{0.1} (atomic ratio, elemental molar ratio).

FIG. 3B is a spectrum for EDS analysis of Ru (Comparative Example 1), and FIG. 3C is a spectrum for EDS analysis of RuAu (Comparative Example 2), the composition of which was confirmed to be Ru₁Au_{0.47}.

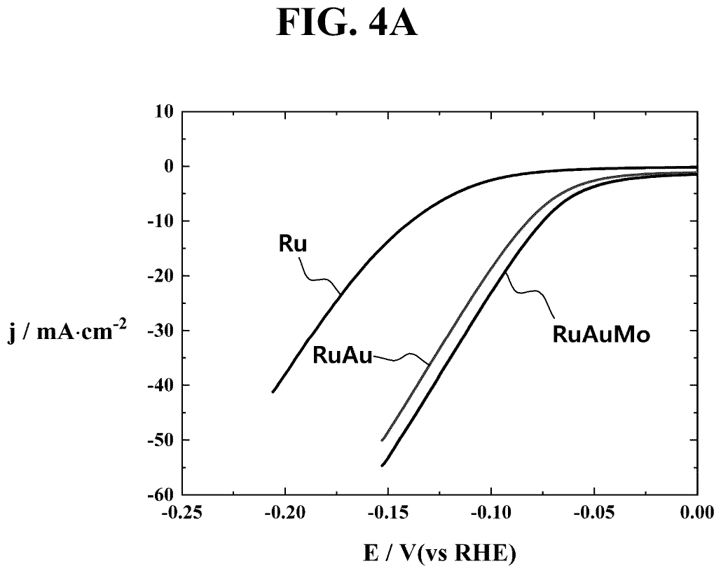

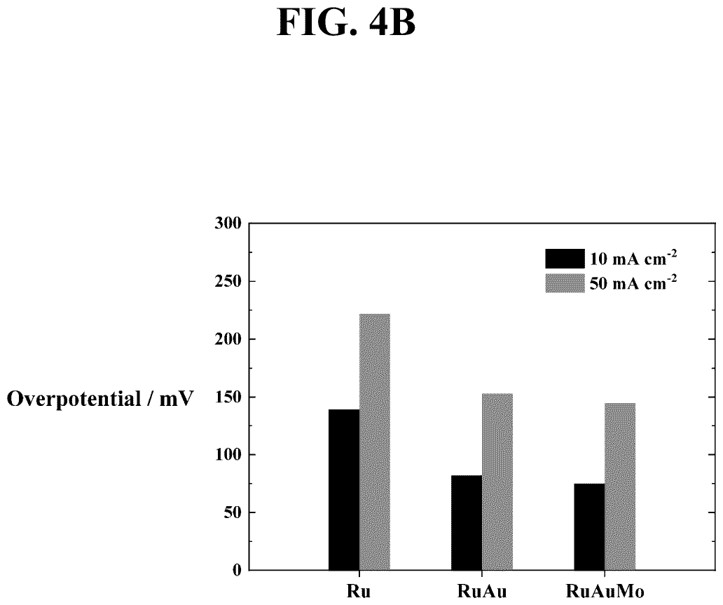

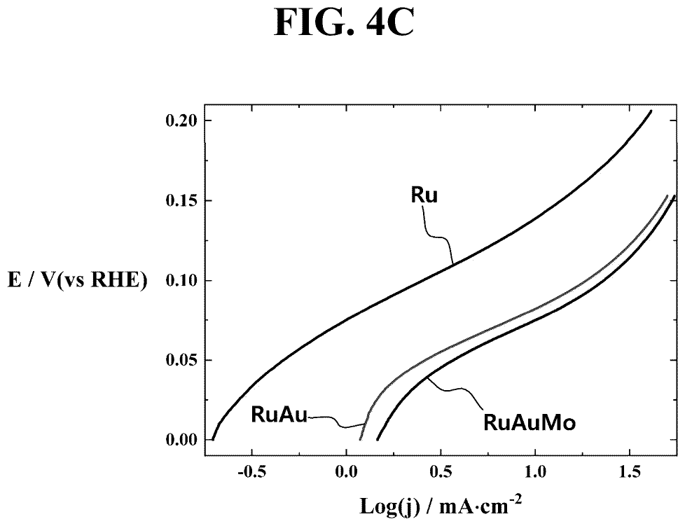

FIGS. 4A to 4C are results of analyzing the HER activity in an acidic condition of the catalyst for a hydrogen evolution reaction for Example 2, and Comparative Examples 1 and 2.

In FIG. 4A, it was confirmed from the LSV graph that Example 2 (RuAuMo), which is composed of three species, showed superior activity on the HER compared to Comparative Example 1 (Ru) and Comparative Example 2 (RuAu), which are composed of single and binary elements.

In FIG. 4B, it was confirmed that the overpotential compared at current densities of −10 mA/cm² and −50 mA/cm² exhibited the lowest value in RuAuMo of Example 1.

From the Tafel plot derived from the LSV graph in FIG. 4C, it was confirmed that Example 2 has a Tafel slope of 65.0 mV/dec, and the corresponding HER is proceeded by the Volmer-Heyrovsky mechanism. In addition, it was confirmed that Example 2 exhibited a lower value than Comparative Example 1 (86.7 mV/dec) and Comparative Example 2 (66.3 mV/dec), and exhibited the superior HER activity due to the synergistic effect of the three elements of Ru, Au, and Mo.

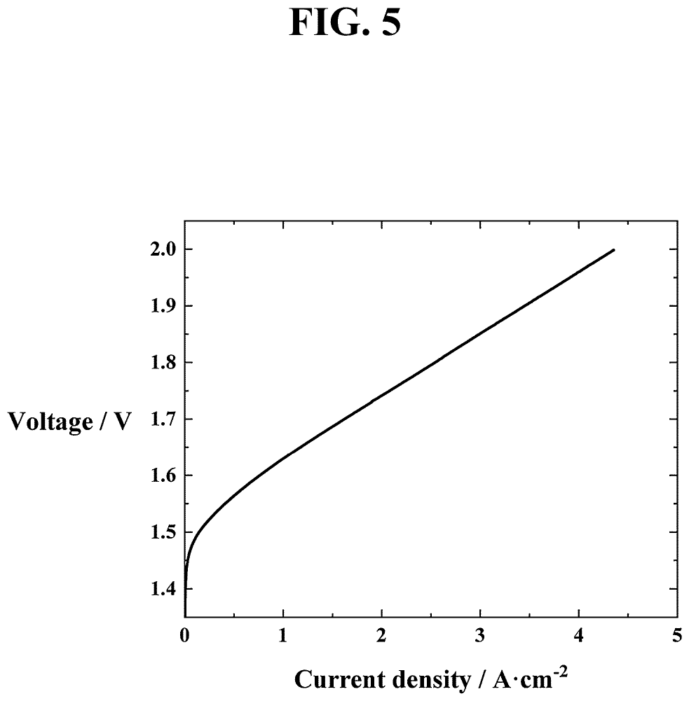

FIG. 5 is a result of analyzing the water electrolysis activity of a RuAuMo electrode manufactured in Example 2.

The water electrolysis activity evaluation was proceeded using the RuAuMo electrode catalyst on the Ti PTL manufactured in Example 2 as the hydrogen evolution electrode of the PEMWE. From the LSV graph for the activity evaluation, the RuAuMo electrode catalyst exhibited a current density of 2.08 A/cm² at a driving voltage of 1.75 V.

### Experimental Example 3—Performance Evaluation According to Plating Potential

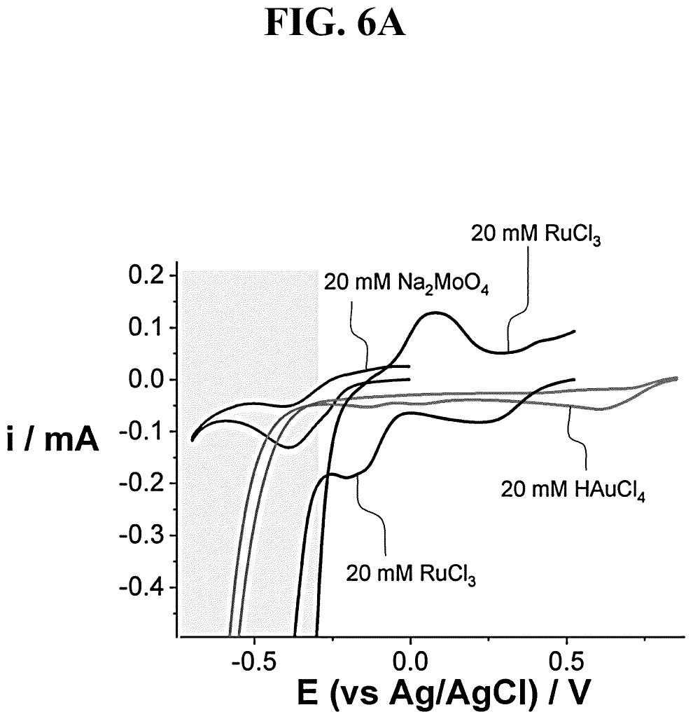

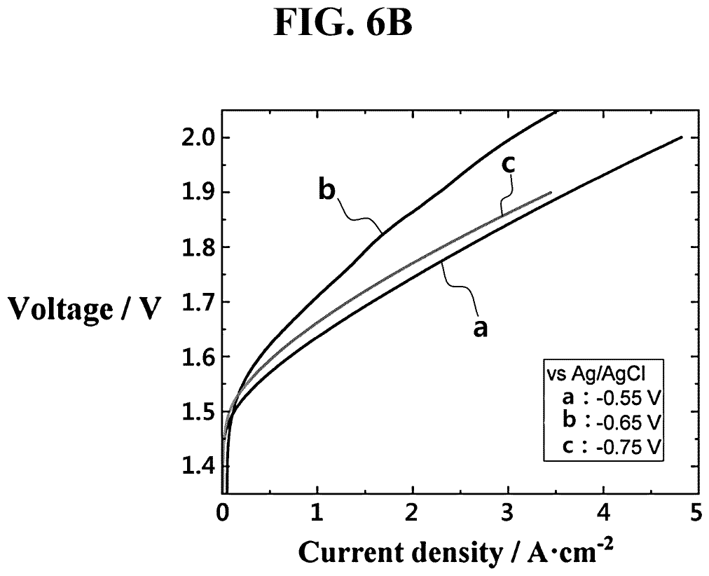

The performance evaluation according to the plating potential was proceeded based on the alloy catalyst manufacturing condition of Example 2. The electrolyte composition was configured as 0.25 M HClO₄+20 mM RuCl₃+2 mM HAuCl₄+2 mM Na₂MoO₄, and the plating time was fixed at 20 minutes. The plating potential was adjusted to −0.55, −0.65, and −0.75 V to observe the change in unit cell performance. The plating potential of the alloy was determined through electrochemical analysis on the plating solution (FIG. 6A), and a potential of −0.3 V (vs Ag/AgCl) or less is required for the plating of all three metals of Ru—Au—Mo.

When the plating potential range determined through the plating electrochemical analysis was applied to the water electrolysis catalyst electrode manufacturing, and the water electrolysis performance for each plating potential of the alloy catalyst was observed, it was confirmed that the best water electrolysis performance was exhibited at −0.55 V, as illustrated in FIG. 6B, and the performance rather decreased when lower plating potentials (−0.65 and −0.75 V) were applied.

### Experimental Example 4—Performance Evaluation According to Plating Time

When an alloy catalyst electrode was manufactured through electroplating (−0.55 V vs Ag/AgCl), the plating time was controlled and the water electrolysis performance was observed accordingly.

Specifically, the performance evaluation according to the plating time was proceeded based on the alloy catalyst manufacturing condition of Example 2. The electrolyte composition was configured as 0.25 M HClO₄+20 mM RuCl₃+2 mM HAuCl₄+2 mM Na₂MoO₄, and the plating potential was fixed at −0.55 V The plating time was adjusted to 2.5, 5, 10, 20, 30, and 60 minutes to observe the change in unit cell performance.

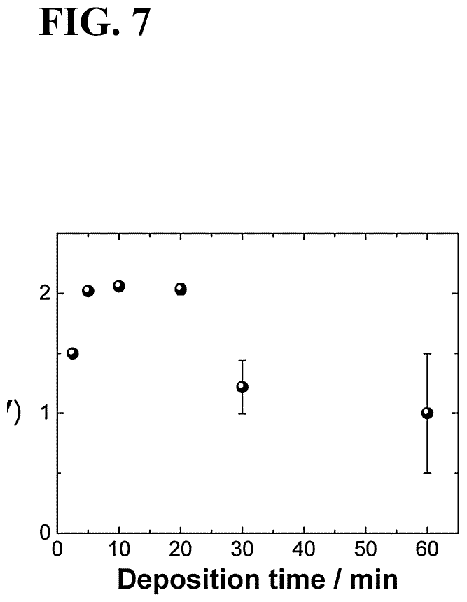

As can be seen in FIG. 7, superior performance compared to other plating time conditions was observed for the plating time ranging from 5 to 20 minutes.

### Experimental Example 5—Performance Evaluation According to Concentration of Electrolyte Solution

The change in the alloy catalyst performance according to the concentration of electrolyte solution was performed through a half-cell test.

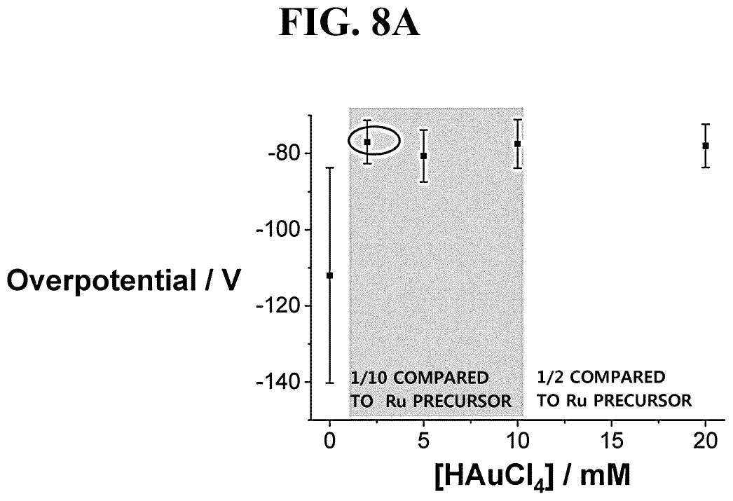

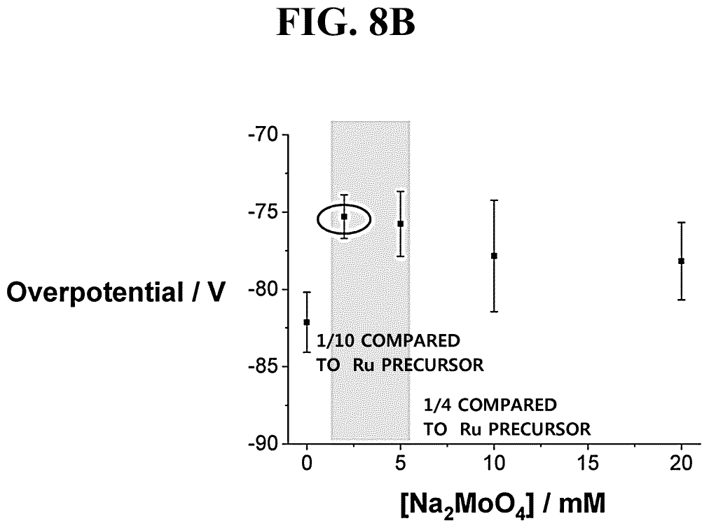

Specifically, the performance evaluation according to the concentration of the Mo precursor was proceeded based on the alloy catalyst manufacturing condition of Example 2. The electrolyte composition was configured as 0.25 M HClO₄+20 mM RuCl₃+2 mM HAuCl₄+X mM Na₂MoO₄, and the concentrations of the Au and Mo precursors were adjusted to 0, 2, 5, 10, and 20 mM to observe the change in half-cell performance. The plating potential and time were fixed at −0.55 V and 20 minutes, respectively. When the concentration of a ruthenium precursor (RuCl₃) in the plating electrolyte solution was fixed at 20 mM, the concentrations of a gold precursor (HAuCl₄) and a molybdenum precursor (Na₂MoO₄) were changed, and the half-cell hydrogen evolution overpotential of the electroplated alloy catalyst was measured, it was confirmed that the same tendency as illustrated in FIGS. 8A and 8B was observed.

In FIG. 8A, the activity was measured while varying the concentration of Au precursor in a plating solution that includes Ru precursor and Au precursor only, resulting in optimization of the concentration of Au precursor, which corresponds to the performance result of the Ru—Au binary catalyst.

In FIG. 8B, the activity was measured while varying the concentration of Mo precursor in a plating solution that includes both Ru precursor, Au precursor, and Mo precursor, resulting in the optimization of the concentration of Mo precursor (on the Ru—Au plating solution pre-optimized in FIG. 8A), which corresponds to the performance result of the Ru—Au—Mo ternary catalyst.

The best performance was observed at 2 mM of each, and it is considered that the plating solution is preferably configured at the concentration condition indicated in the color.

What is claimed is:

1. A catalyst for a hydrogen evolution reaction, the catalyst comprises:
a support; and
a ruthenium alloy electroplated on the support,
wherein the alloy comprises ruthenium, and two or more metals selected from the group consisting of Au, Ni, Co, Mo, and Cu.

2. The catalyst of claim 1, wherein the support is titanium or carbon.

3. The catalyst of claim 1, wherein the ruthenium alloy includes ruthenium, Au, and Mo.

4. The catalyst of claim 1, wherein the ruthenium alloy is represented by Chemical Formula 1 below:
RuₓAu_{y}Mo_{(1-y)} [Chemical Formula 1]
In Chemical Formula 1, x is 1, and y is 0 to 1.

5. A hydrogen evolution electrode comprising the catalyst according to claim 1.

6. A water electrolysis electrode comprising the hydrogen electrode according to claim 5.

7. The water electrolysis electrode of claim 6, wherein the water electrolysis is a polymer electrolyte membrane water electrolysis (PEMWE) electrode.

8. A method of manufacturing a catalyst for a hydrogen evolution reaction, the method comprises:
preparing a precursor including a ruthenium precursor and a precursor including two or more metals selected from the group consisting of Au, Ni, Co, Mo, and Cu; and
electroplating a ruthenium alloy on a support using the precursors.

9. The method of claim 8, wherein the support is titanium or carbon.

10. The method of claim 8, wherein the precursor including two or more metals selected from the group consisting of Au, Ni, Co, Mo, and Cu include an Au precursor and a Mo precursor.

11. The method of claim 8, wherein the precursor including at least two metals selected from the group consisting of Au, Ni, Co, Mo, and Cu includes an Au precursor and a Mo precursor, and
wherein a concentration ratio of the ruthenium precursor, the Au precursor, and the Mo precursor is 1:0.05 to 0.5:0.05 to 0.25.

12. The method of claim 8, wherein the method is performed at room temperature.

13. The method of claim 8, wherein the electroplating potential is −0.4 to −0.8 V_{Ag/AgCl}.

14. The method of claim 8, wherein the electroplating time is 3 to 30 minutes.
